(19) United States
(12) Patent Application Publication
(10) Pub. No.: US 2020/0133211 A1
(43) Pub. Date: Apr. 30, 2020

(54) ELECTRONIC DEVICE AND METHOD FOR CONTROLLING ELECTRONIC DEVICE THEREOF

(71) Applicant: Samsung Electronics Co., Ltd., Suwon-si (KR)

(72) Inventors: Jaehun LEE, Suwon-si (KR); Yunsu LEE, Suwon-si (KR); Taeho HWANG, Suwon-si (KR); Jungho PARK, Suwon-si (KR); Mirae JEONG, Suwon-si (KR); Jiyoung KANG, Suwon-si (KR)

(21) Appl. No.: 16/658,914

(22) Filed: Oct. 21, 2019

(30) Foreign Application Priority Data
Oct. 26, 2018 (KR) 10-2018-0129351

(51) Int. Cl. G05B 13/04; G05B 13/02

(52) U.S. Cl. CPC G05B 13/048; G05B 13/0265

(57) ABSTRACT

An electronic device for performing a control operation and a method therefor are provided. The electronic device includes a communication interface, a memory to store at least one command, and a processor connected to the communication interface and the memory. The processor is configured to, by executing the at least one command, based on usage information of a first user using the electronic device, establish a first device knowledge base by obtaining a first control condition and a first control operation preferred by a first user, based on a context corresponding to the first control condition being detected, identify whether to perform the first control operation stored in the first device knowledge base based on a basic knowledge base that stores information on the context and information on the electronic device, and based on a result of the identification, control the electronic device.

### CROSS-REFERENCE TO RELATED APPLICATION(S)

This application is based on and claims priority under 35 U.S.C. § 119 of a Korean patent application number 10-2018-0129351, filed on Oct. 26, 2018, in the Korean Intellectual Property Office, the disclosure of which is incorporated by reference herein in its entirety.

### BACKGROUND

### 1. Field

The disclosure relates to an electronic device and a controlling method thereof. More particularly, the disclosure relates to an electronic device for performing an optimal control operation corresponding to context based on a basic knowledge base and a device knowledge base and a controlling method thereof.

### 2. Description of Related Art

Recently, artificial intelligence systems that implement human-level artificial intelligence (AI) have been used in various fields. An artificial intelligence system is a system in which the machine learns, judges and becomes smart, unlike a conventional rules-based smart system. The more the artificial intelligence system is used, the higher the recognition rate and the better understanding of user's preferences. Thus, the conventional rule-based smart system has been gradually replaced by a deep-learning based artificial intelligence system.

Artificial intelligence technology consists of machine learning (e.g., deep-learning) and element technologies that use machine learning.

Machine learning is an algorithm technology that classifies/trains the characteristics of input data by itself. Element technology is a technology that simulates functions, such as recognition and judgment of the human brain, using a machine learning algorithm such as deep learning and includes linguistic understanding, visual understanding, reasoning/prediction, knowledge representation, motion control, etc.

Artificial intelligence technology may be applied to various fields, examples of which are described below. Linguistic understanding is a technology for recognizing and applying/processing human language/characters, including natural language processing, machine translation, dialogue system, query response, speech recognition/synthesis, and the like. Visual comprehension is a technology for recognizing and processing an object as if perceived by a human being, including object recognition, object tracking, image search, human recognition, scene understanding, spatial understanding, image enhancement, etc. Inference prediction is a technology for judging and logically inferring and predicting information, including knowledge/probability-based reasoning, optimization prediction, preference-bases planning, and recommendations. Knowledge representation is a technology for automating human experience information into knowledge data, including knowledge building (data generation/classification) and knowledge management (data utilization). Motion control is a technology for controlling the autonomous movements of a device or object, e.g., travel of a vehicle and the motion of a robot, including motion control (navigation, collision and traveling), operation control (behavior control), and the like.

Meanwhile, recently, an electronic device becomes capable of performing its function automatically without a control command of a user based on setting information pre-set by the user or user preference information.

However, it is inappropriate to control an electronic device based on preset setting information or user's preference information in an Internet of Things (IoT) environment in which multiple users control a single electronic device. In addition, in the case of a conventional electronic device, functions of the electronic device are controlled based on setting information or preference information without considering various contexts, so that a problem may occur that a control operation of the electronic device unintended by a user could be performed.

Therefore, there is a demand for a method for effectively controlling an electronic device even in a situation in which information on various contexts is obtained or a plurality of uses use an electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device capable of performing an optimal control operation corresponding to a context based on a basic knowledge base and a device knowledge base and a controlling method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, a memory configured to store at least one command, and aprocessor connected to the communication interface and the memory. The processor is configured to, by executing the at least one command, based on usage information of a first user using the electronic device, establish a first device knowledge base by obtaining a first control condition and a first control operation preferred by a first user, based on a context corresponding to the first control condition being detected, identify whether to perform the first control operation stored in the first device knowledge base based on a basic knowledge base that stores information on the context and information on the electronic device, and based on a result of the identification, control the electronic device.

In accordance with another aspect of the disclosure, a method for controlling an electronic device is provided. The method includes establishing a first device knowledge base by obtaining a first control condition and a first control operation preferred by a first user based on usage information of a first user using the electronic device, based on a context corresponding to the first control condition being detected, identifying whether to perform the first control operation stored in the first device knowledge base based on a basic knowledge base that stores information on the context and information related to the electronic device, and controlling the electronic device based on a result of the identification.

According to the above-described various embodiments, an electronic device performs a control operation corresponding to a context to provide an optical user experience.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view to explain a usage diagram of an electronic device capable of performing a control operation in accordance with a context according to an embodiment of the disclosure;

FIGS. 2 and 3 are block diagrams to explain configuration of an electronic device according to various embodiments of the disclosure;

FIG. 4 is a flowchart to explain a method for performing a control operation in accordance with a context according to an embodiment of the disclosure;

FIGS. 5, 6, and 7 are views to explain a method for establishing a knowledge base according to various embodiments of the disclosure;

FIGS. 8, 9A, and 9B are views to explain an example embodiment for performing a control operation corresponding at least one of a plurality of users in accordance with a context according to various embodiments of the disclosure;

FIG. 10 is a flowchart to explain a method for performing a control operation corresponding one of a plurality of users in accordance with a context according to an embodiment of the disclosure;

FIGS. 11, 12, and 13 are block diagrams to explain configuration of a processor according to various embodiments of the disclosure; and

FIG. 14 is a view illustrating an example in which an electronic device is operable in association with a server to train and recognize data according to an embodiment of the disclosure.

Throughout the drawings, it should be noted that like reference numbers are used to depict the same or similar elements, features, and structures

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The singular expression also includes the plural meaning as long as it does not differently mean in the context. In this specification, terms such as ‘include’ and ‘have/has’ should be construed as designating that there are such features, numbers, operations, elements, components or a combination thereof in the specification, not to exclude the existence or possibility of adding one or more of other features, numbers, operations, elements, components or a combination thereof.

In the disclosure, the expressions “A or B,” “at least one of A and/or B,” or “one or more of A and/or B,” and the like include all possible combinations of the listed items. For example, “A or B,” “at least one of A and B,” or “at least one of A or B” refers to (1) includes at least one A, (2) includes at least one B or (3) includes at least one A and at least one B.

Terms such as ‘first’ and ‘second’ may be used to modify various elements regardless of order and/or importance. Those terms are only used for the purpose of differentiating a component from other components.

When an element (e.g., a first constituent element) is referred to as being “operatively or communicatively coupled to” or “connected to” another element (e.g., a second constituent element), it should be understood that each constituent element is directly connected or indirectly connected via another constituent element (e.g., a third constituent element). However, when an element (e.g., a first constituent element) is referred to as being “directly coupled to” or “directly connected to” another element (e.g., a second constituent element), it should be understood that there is no other constituent element (e.g., a third constituent element) interposed therebetween.

The expression “configured to” as used in the disclosure can refer to, for example, “suitable for,” “having the capacity to,” “designed to,” “adapted to,” “made to,” or “capable of” depending on the situation. The term “configured to (or set to)” may not necessarily mean “specifically designed to” in hardware. Instead, in some circumstances, the expression “a device configured to” may mean that the device “is able to˜” with other devices or components. For example, “a sub-processor configured to (or set to) execute A, B, and C” may be implemented as a processor dedicated to performing the operation (e.g., an embedded processor), or a generic-purpose processor (e.g., a central processor unit (CPU) or an application processor) that can perform the corresponding operations.

The electronic device according to various embodiments of the disclosure may be a smartphone, a tablet personal computer (a table PC), a mobile phone, a video phone, an e-book reader, a laptop personal computer (a laptop PC), a netbook computer, a personal digital assistant (PDA), a portable multimedia player (PMP), an MP3 player, a mobile medical device, a camera, or a wearable device, or they may be part of them. A wearable device may be an accessory type device such as a watch, a ring, a bracelet, a bracelet, a necklace, a pair of glasses, a contact lens or a head-mounted-device (HMD), a fabric or a garment-all-in-one type (e.g., electronic outfit), a body attachment type (e.g., a skin pad or a tattoo), or a bio-implantable circuit.

In some embodiments, examples of the electronic device may be home appliances. The home appliances may include, at least one of, for example, a television, a digital video disk (DVD) player, an audio, a refrigerator, an air conditioner, a vacuum cleaner, an oven, a microwave oven, a washing machine, a set-top box, a home automation control panel, a security control panel, a TV box (e.g., Samsung HomeSync™, Apple TV™, or Google TV™), a game console (e.g., Xbox™, and PlayStation™), an electronic dictionary, an electronic key, a camcorder, or an electronic frame.

In another embodiment, the electronic device may be any of a variety of medical devices (e.g., various portable medical measurement devices such as a blood glucose meter, a heart rate meter, a blood pressure meter or a body temperature meter), a magnetic resonance angiography (MRA), a magnetic resonance imaging (MRI), a computed tomography (CT), a camera, an ultrasonic device, a navigation device, a global navigation satellite system (GNSS), an event data recorder (EDR), a flight data recorder (FDR), an automobile infotainment device (e.g., navigation devices, gyro compasses, etc.), avionics, security devices, head units for vehicles, industrial or home robots, automatic teller's machine (ATMs) of financial institutions, point of sale (POS) of a store, or internet of things such as a light bulb, various sensors, an electric or gas meter, a sprinkler device, a fire alarm, a thermostat, a street lamp, a toaster, an exercise device, a hot water tank, a heater, boiler, etc.

In this specification, a user may refer to a person that uses an electronic device or a device that uses an electronic apparatus (e.g., an artificial intelligence electronic apparatus).

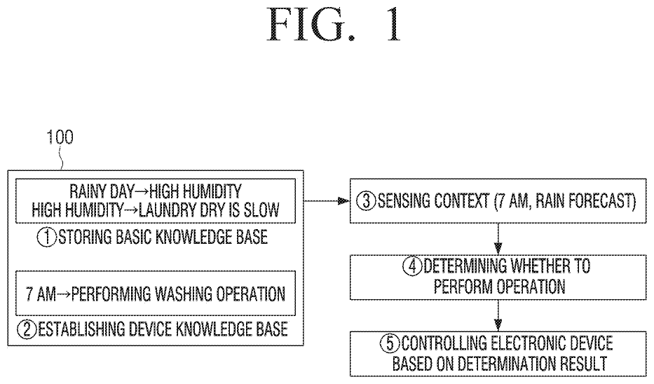

FIG. 1 is a view to explain a usage diagram of an electronic device capable of performing a control operation in accordance with a context according to an embodiment of the disclosure.

The electronic device 100 may store a basic knowledge base. The basic knowledge base may store general knowledge information related to the electronic device 100 (e.g., information on the function, setting, and structure of the electronic device 100). The basic knowledge base may be received from an external server. However, the disclosure is not limited thereto, but the basic knowledge base could be pre-generated and stored at the time of manufacturing the electronic device 100. The basic knowledge base may store knowledge information, attributes of knowledge information, relations between knowledge information, etc. in the form of a knowledge graph. For example, when the electronic device 100 is a washing machine, referring to FIG. 1, the electronic device 100 may store a basic knowledge base including information on a washing machine such as “rainy day->high humidity”, “high humidity->laundry drying is slow”.

The electronic device 100 may obtain a control condition and a control operation based on user information of a user that uses the electronic device 100 and establish a device knowledge base including the obtained control condition and control operation. The device knowledge base may be a knowledge base that stores information on the user that uses the electronic device 100, and may store various knowledge information obtained based on the usage information of the user. The electronic device 100 may store knowledge information, attributes of the knowledge information, relations between the knowledge information, etc. in the form of a knowledge graph. Establishing the device knowledge base may include not only generating a new device knowledge base but also adding the obtained control condition and control operation to the pre-generated device knowledge base. The device knowledge base is merely exemplary, but could be interchangeably used with a personal knowledge base, and a user knowledge base.

The electronic device 100 may recognize a user that uses the electronic device 100, but also may obtain a control command by which the recognized user controls the electronic device 100. The electronic device 100 may sense a context when obtaining the control command, and obtain a control condition corresponding to the control command. The context information may include at least one of ambient environment information of the electronic device 100, user status information of the electronic device 100, user history information of the electronic device 100, and user schedule information of the user. However, the disclosure is not limited thereto.

The ambient environment information of the electronic device 100 may refer to environment information within a predetermined radius from the electronic device 100 and include environmental information such as weather information, temperature information, humidity information, illuminance information, noise information, sound information, etc. but the disclosure is not limited thereto. The state information of the electronic device 100 may include mode information of the electronic device 100 (e.g., a sound mode, a vibration mode, a silent mode, a power saving mode, a cutoff mode, a multi-window mode, an automatic rotation mode, etc.), location information of the electronic device 100, time information, activation information of a communication module (e.g., Wi-Fi ON/Bluetooth OFF/GPS ON/NFC ON, etc.), network connection state information of the electronic device 100, application information executed by the electronic device (e.g., application identification information, application type, application usage time, application usage cycle, etc.), and the like, but is not limited thereto. The user's state information may include information on the user's movement, life pattern, etc., and may include information on the user's walking state, running state, exercising state, driving state, sleeping state, user's mood state, and the like, but is not limited thereto. The user's usage history information of the electronic device 100 may be information on the history of the user for using the electronic device 100, including history of execution of applications, history of functions executed in the applications, user's call history, user's text history, etc. but is not limited thereto.

The electronic device 100 may establish a device knowledge base by matching a control condition with a control operation corresponding to the control command. For example, when a user that uses the electronic device 100 inputs a control command for performing a washing operation every 7:00 am, referring to FIG. 1, the electronic device 100 may match a control condition ‘7 am’ with ‘washing operation’ to establish the device knowledge base.

It is merely exemplary that the electronic device 100 obtains a control condition and a control operation based on usage information of a user, but the control condition and the control operation may be input by the user. For example, the electronic device 100 may display a user interface (UI) for inputting a control condition and a control operation preferred by the user. When a control condition and a control operation are set through the UI, the electronic device 100 may establish a device knowledge base based on information on a first control condition and a first control operation.

For another example, the electronic device 100 may establish a device knowledge base by obtaining a knowledge graph including information on a relationship between a control condition and a control operation preferred by a user by inputting usage information of the user (e.g., context and control command) into a trained artificial intelligence model.

In the above-described embodiment, the device knowledge base is constructed by matching a control condition with a control operation. However, it is merely an example, and a control condition and a control operation could be matched and stored in a pre-established device knowledge base.

The electronic device 100 may transmit a device knowledge base to an external server and expand (or update) the device knowledge base.

The electronic device 100 may sense the context corresponding to the control condition stored in the device knowledge base. The electronic device 100 may sense information on a context through various sensors, but it is merely exemplary. The context may be detected through various methods such as schedule information input by a user, information received from an external device, etc. For example, referring to FIG. 1, the electronic device 100 may obtain information that it reaches 7 am and obtain information regarding rain forecast through a sensor.

The electronic device 100 may determine (identify) whether to perform a control operation corresponding to a control condition based on information on a context and a basic knowledge base. The electronic device 100 may determine whether to perform a control operation by inferring whether the result of performing the first control operation on the currently sensed (detected) context is the same as the result of performing the first control operation predicted by a first user based on the information related to the context stored in the basic knowledge base.

When the result of performing the control operation on the sensed context is the same as the result of performing the first control operation predicted by the first user, the electronic device 100 may perform the control operation. However, when the result of performing the first control operation on the sensed context is different from the result of performing the first control operation predicted by the first user, the electronic device 100 may not perform the control operation.

For example, if the electronic device obtains information on the context “7 am, rain forecast”, then the electronic device 100 may, based on the information associated with the context stored in the base knowledge base, “rainy day->high humidity ->laundry drying is slow”, may obtain a result in which the sensed context “rain forecast” is subject to the control operation of performing a washing operation “laundry drying is slow”. Therefore, the electronic device 100 may not perform the “washing operation” which is the control operation because it is determined that the result ‘laundry drying is slow’ and the result predicted by the user performing the washing operation are different from each other.

As another example, if the electronic device obtains information on the context of “7 am, sunny day”, the electronic device 100 may determine that the result of performing the control operation on the detected context and the result of performing the control operation predicted by the user are the same, and perform the control operation “washing operation”.

The electronic device 100 may control the electronic device 100 based on the determination result. Specifically, if it is determined that the electronic device 100 performs the control operation, the electronic device 100 may control the electronic device 100 based on the control operation stored in the device knowledge base. If it is determined that the electronic device 100 is not performing a control operation, the electronic device 100 may not perform the control operation stored in the device knowledge base. The electronic device 100 may recommend information on a second control operation to obtain the same result as the result of performing the control operation predicted by the user on the currently sensed context. For example, the electronic device 100 may provide the user with a recommendation message “run the washing machine in sunny day” or “would you like to run the washing machine by adding 30 minutes of drying operation?”.

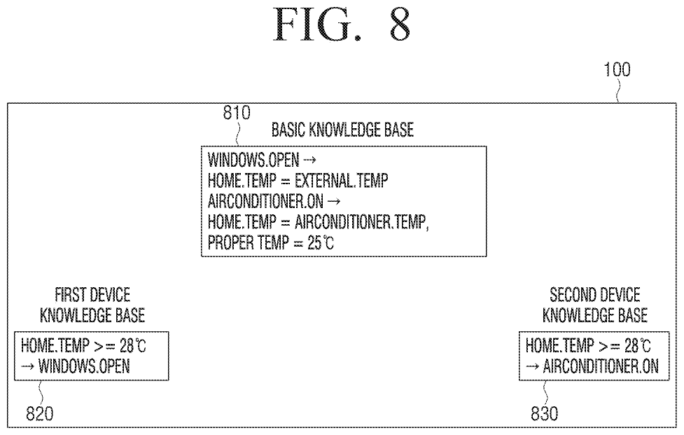

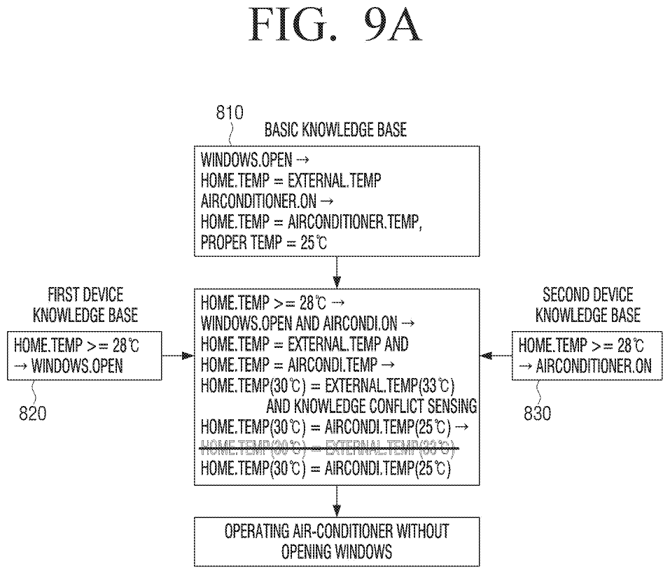

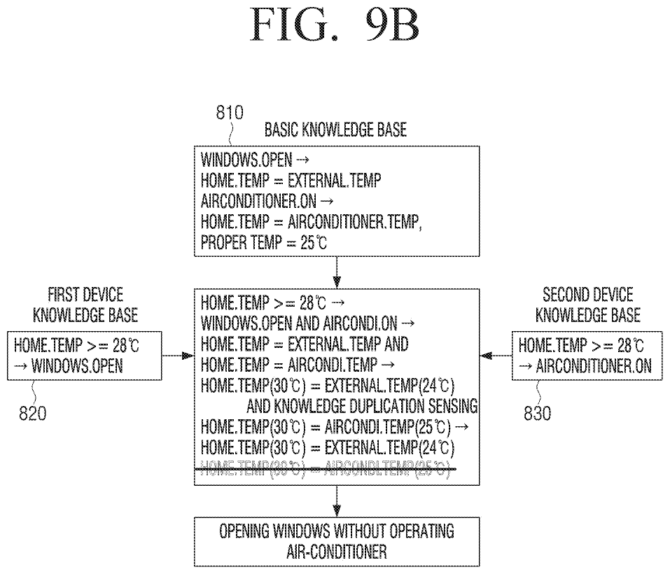

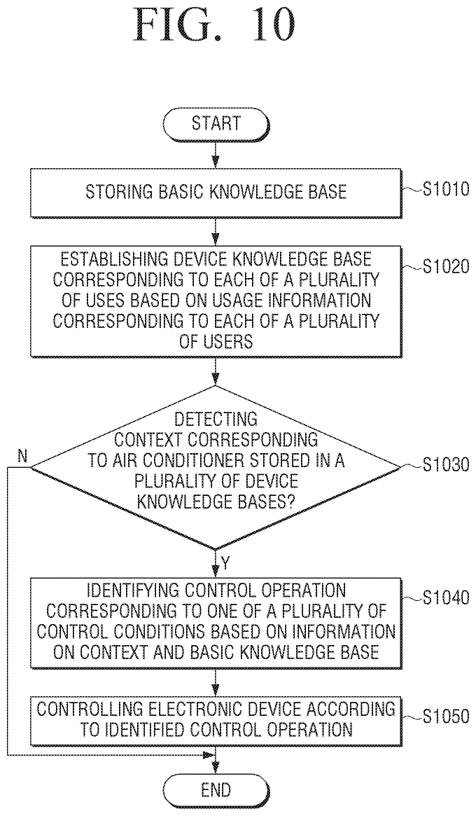

In the above-described embodiment, the optimal control operation according to the context has been performed based on the device knowledge base corresponding to one user. However, the disclosure is not limited thereto. The technical spirit of the disclosure can also be applied to performing an optimal control operation according to a context based on a plurality of device knowledge bases. This will be described later in detail with reference to FIG. 8, FIG. 9A, FIG. 9B and FIG. 10.

Meanwhile, the first artificial intelligence model for constructing the device knowledge base mentioned in the above embodiment may be an artificial intelligence algorithm, which is trained by using at least one of machine learning, neural network, gene, deep learning, and classification algorithm. In particular, the first artificial intelligence model may be a judgment model trained based on an artificial intelligence algorithm, for example, a model based on a neural network. The trained first artificial intelligence model may include a plurality of weighted network nodes that simulate a neuron of a human neural network. The plurality of network nodes may each establish a connection relationship so that the neurons simulate synaptic activity of the neurons sending and receiving signals via synapses. The trained first artificial intelligence model may include, for example, a neural network model or a deep learning model developed from the neural network model. In the deep learning model, a plurality of network nodes may be located at different depths (or layers) and may exchange data according to a convolution connection relationship. Examples of the trained first artificial intelligence model include Deep Neural Network (DNN), Recurrent Neural Network (RNN), and Bidirectional Recurrent Deep Neural Network (BRDNN), but the disclosure is not limited thereto.

In addition, the electronic device 100 may use a personal assistant program, which is an artificial intelligence agent (artificial intelligence agent), to perform a control operation corresponding to the context as described above. The personal assistant program may be a dedicated program for providing an Artificial Intelligence (AI)-based service and executed by a conventional general-purpose processor (e.g., a CPU) or a separate AI-specific processor (e.g., a graphical processing unit (GPU)).

Specifically, when a predetermined user input (e.g., a user voice including a predetermined word (trigger word or wakeup word) or the like) is input or a button provided in the electronic apparatus or electronic device 100 (e.g., a button for executing the artificial intelligence agent) is pressed, the artificial intelligence agent may operate (or execute). The artificial intelligence agent may perform a control operation corresponding to the context based on the information on the detected context.

When a predetermined user input is input, and a button provided in the electronic device 100 is pressed, an artificial intelligence agent may operate. The artificial intelligence agent may be pre-executed before a predetermined user input is input or a button provided in the electronic device 100 is pressed. In this case, after the predetermined user input is input or the button provided in the electronic device 100 is pressed, the artificial intelligence agent of the electronic device 100 may perform a control operation corresponding to the context based on the information on the context.

An artificial intelligence agent may be in a standby state when a predetermined user input is input or a button provided in the electronic device 100 is pressed. The standby state may refer to a state in which a pre-defined user input is received for controlling an operation start of the artificial intelligence agent. While the artificial intelligence agent is in the standby state, when the predetermined user input is input or the button provided in the electronic device 100 is pressed, the electronic device 100 may operate an artificial intelligence agent, and perform a control operation corresponding to a context based on information on the context.

In addition, the artificial intelligence agent may be in a standby mode when a predetermined user input is input or the button provided in the electronic device 100 is pressed. The standby mode may be a state in which a pre-defined user input is received for controlling the start of the artificial intelligence agent. When a predetermined user input is input or the button provided in the electronic device 100 is pressed while the artificial intelligence agent is in the standby mode, the electronic device 100 may operate the artificial intelligence agent, and perform a control operation corresponding to the context based on information on the context.

An artificial intelligence agent may control various devices or modules to be described. A detailed description thereof will be described.

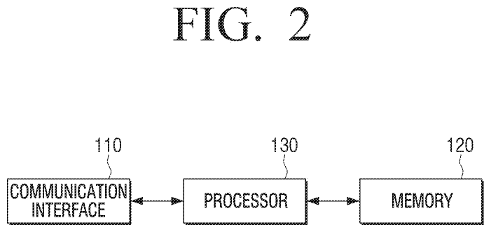

FIG. 2 is a block diagram to explain configuration of an electronic device according to an embodiment of the disclosure.

Referring to FIG. 2, an electronic device 100 may include a communication interface 110, a memory 120, and a processor 130. However, the disclosure is not limited the above-described configurations. Depending on various types of electronic devices, some configurations may be added or omitted.

The communication interface 110 may perform communication with an external electronic device. The communication interface 110 may be configured to perform communication with an external device. Communication between the communication interface 110 and the external device may refer to performing communication via a third device (e.g., relay device, hub, access point, server or gateway). The wireless communication may include, for example, long term evolution (LTE), LTE Advanced (LTE-A), code division multiple access (CDMA), wideband CDMA (WCDMA), universal mobile telecommunications system (UMTS), wireless broadband (Wi-Bro) or Global System for Mobile Communications (GSM), and the like. According to an embodiment, the wireless communication may include at least one of, for example, wireless fidelity (Wi-Fi), Bluetooth, Bluetooth low power (BLE), Zigbee, near field communication (NFC), Magnetic Secure Transmission, Frequency (RF), or body area network (BAN). The wired communication may include, for example, at least one of a universal serial bus (USB), a high definition multimedia interface (HDMI), a recommended standard 232 (RS-232), a power line communication or a plain old telephone service. The network over which the wireless or wired communication is performed may include at least one of a telecommunication network, e.g., a computer network (e.g., a local area network (LAN) or wide area network (WAN)), the Internet, or a telephone network.

The communication interface 110 may receive a device knowledge base updated by performing communication with an external server.

The communication interface 110 may receive various information (e.g., sensing information, weather information, time information, schedule information, etc.) in order to obtain a context from an external device.

The memory 120 may store various programs and data necessary for the operation of the electronic device 100. The memory 120 may be implemented with a non-volatile memory, a volatile memory, a flash memory, a hard disk drive (HDD), or a solid state drive (SSD). The memory 120 may be accessed by the processor 130 and reading/writing/modifying/deleting/updating operations of data may be performed by the processor 130. The term ‘memory’ in this disclosure may include the memory 120, and a memory card (not shown) (e.g., a micro secure digital (SD) card, a memory stick, etc.) mounted in read-only memory (ROM) (not shown), random access memory (RAM) (not shown) or the electronic device 100. The memory 120 may store programs and data for constructing various screens to be displayed on a display area of a display.

The memory 120 may store an artificial intelligence agent for performing a control operation corresponding to a context. The artificial intelligence agent may be a dedicated program for providing artificial intelligence (AI) based service (e.g., voice recognition service, secretary service, translation service, search service, etc.). Particularly, the artificial intelligence agent may be executed by a conventional general-purpose processor (e.g., a CPU) or an additional AI processor (e.g., a GPU).

The memory 120 may store a basic knowledge base and a device knowledge base. The basic knowledge base may be a knowledge base for storing knowledge information related to an electronic device, and store relations between knowledge bases, etc. in the form of a knowledge graph. The memory 120 may receive the basic knowledge base from an external server or an external device. However, the disclosure is not limited thereto, but the basic knowledge base may be pre-stored at the time of manufacturing the product. The basic knowledge base may be a knowledge base for storing information related to a user, and obtained based on user information and setting information of the user. The device knowledge base may store a control condition and a control operation matched with each other. The device knowledge base may be generated or added (updated) by the user's usage information or the setting information, or expanded from an external server.

The processor 130 may be electrically connected to the memory 120 to control the overall operation and function of the electronic device 100. By executing at least one command stored in the memory 120, the processor 130 may establish a first device knowledge base by obtaining the first control condition and the first control operation preferred by the first user based on the usage information of the first user. When the context corresponding to the first control condition is sensed, the processor 130 may determine whether to perform the first control operation stored in the first device knowledge base based on the basic knowledge base that stores the information on the context and the information related to the electronic device. The processor 130 may control an electronic device based on a determination result.

The processor 130 may establish the first device knowledge base corresponding to the first user. The processor 130 may obtain the first control condition and the first control operation preferred by the first user based on the usage information of the first user, and establish the first device knowledge base by matching the obtained first control condition with the first control operation. The processor 130 may control a display to display a UI for inputting the control condition and the control operation preferred by the user, and when the first control condition and the first control operation are set through a UI, the processor 130 may establish the first device knowledge base by matching the first control condition with the first control operation. The processor 130 may establish a device knowledge base by obtaining a knowledge graph including information on a relationship between the first control condition and the first control operation preferred by the first user by inputting the usage information of the first user to the trained first artificial intelligence model.

The processor 130 may sense a context corresponding to the first control condition stored in the device knowledge base. The processor 130 may sense the text based on sensing information obtained from the sensor provided in the electronic device 100 and sensing information received from the external sensing device, and sense the context from the various information stored in the memory 120 (e.g., schedule information) or information received from the external device (e.g., weather information).

When the context corresponding to the first control condition is sensed, the processor 130 may determine whether to perform the first control operation stored in the first device knowledge base by determining whether the result of performing the first control operation on the sensed context is the same as the result of performing the first control operation predicted by the first user based on the information related to the context stored in the basic knowledge base. When the result of performing the first control operation on the sensed context is the same as the result of performing the first control operation predicted by the first user, the processor 130 may determine that the first control operation corresponding to the first control condition is performed. However, the result of performing the first control operation on the sensed context is different from the result of performing the first control operation predicted by the user, the processor 130 may determine that the first control operation is not performed. When it is determined that the first control operation is not performed, the processor 130 may recommend information on the second control operation for obtaining the result same as the result of performing the first control operation predicted by the first user based on the sensed context.

The processor 130 may perform the control operation corresponding to the context based on a plurality of device knowledge bases corresponding to a plurality of users. To be specific, the electronic device 100 may establish the second device knowledge base by obtaining the second control condition and the second control operation preferred by the second user based on the usage information of the second user that uses the electronic device 100 other than the first user.

The processor 130 may sense the context corresponding to both the first control condition and the second condition. When the context corresponding to the first control condition and the second control condition is sensed, the processor 130 may determine at least one of the first control operation or the second control operation based on the device knowledge base that stores the information on the context and the information related to the electronic device, and execute one of the first control operation and the second control operation. The processor 130 may determine the result of performing the first control operation and the result of performing the second control operation on the context sensed based on the information on the context stored in the device knowledge base. The processor 130 may determine a control operation that has a performance result predicted by a user between the result of performing the first control operation and the result of performing the second control operation as a control operation to be executed by the electronic device. The processor 130 may determine a control operation that has a performance result predicted by users among a plurality of control operations and perform the determined control operation.

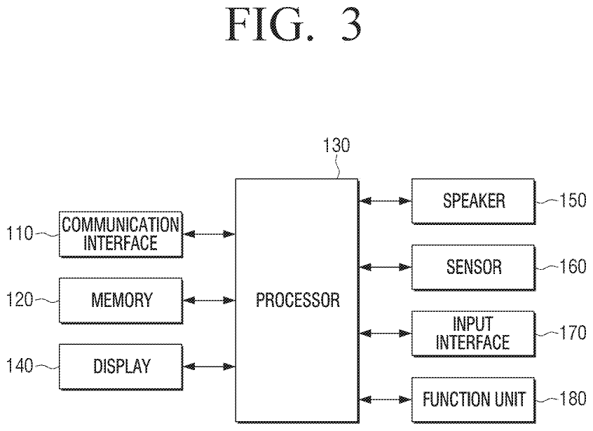

FIG. 3 is a block diagram to explain configuration of an electronic device according to an embodiment of the disclosure.

Referring to FIG. 3, an electronic device 100 may include a communication interface 110, a memory 120, a display 140, a speaker 150, a sensor 160, an input interface 170, a function unit 180 and a processor 130. The communication interface 110, the memory 120, and the processor 130 have been described in FIG. 2. Therefore, a repeated description will be omitted.

The display 140 may display various information under the control of the processor 130. When it is determined that a control operation is performed by the processor 130, the display 140 may display a guide message for guiding a control operation corresponding to the context, and when it is determined that the control operation is not performed by the processor 130, the display 140 may display a recommendation message including information on the second control operation for obtaining the same result with the result of performing the first control operation predicted by the first user on the sensed context.

The display 140 may display a UI for setting a control condition and a control operation preferred by a user.

The speaker 150 may be configured to output various alarming sounds or voice messages as well as various audio data in which various processing such as decoding, amplification, and noise filtering are processed by an audio processor. The speaker 150 may provide guide messages and recommendation messages provided by a display in the form of audio. The guide messages and the recommendation messages may be voice messages processed in the form of natural language. The configuration for outputting audio may be embodied as a speaker, but it is merely exemplary. It could be embodied as an output terminal for outputting audio data.

The sensor 160 may be configured to sense various state information of the electronic device 100. For example, the sensor 160 may include a movement sensor for sensing movement information (e.g., gyro sensor, an acceleration sensor, etc.), a sensor for sensing location information (e.g., Global Positioning System (GPS) sensor), a sensor for sensing environmental information near the electronic device 100 (e.g., a temperature sensor, a humidity sensor, an air pressure sensor, etc.), a sensor for sensing user information of the electronic device 100 (e.g., a blood pressure sensor, a blood glucose sensor, a pulse rate sensor, etc.), etc. In addition, the sensor 160 may further include an image sensor or the like for photographing the outside of the electronic device 100.

The input interface 170 may receive user input for controlling the electronic device 100. In particular, the input interface 170 may receive a user input for setting a control condition and a control operation preferred by the user. The input interface 170 may include a microphone for receiving a user's voice, a touch panel for receiving a user's touch using a user's hand or a stylus pen, and a button for receiving a user's operation. However, the disclosure is not limited thereto, but the input interface 170 may be embodies as other input devices (e.g., a keyboard, a mouse, a motion input, and the like).

The function unit 180 may be configured to perform its own function of the electronic device 100. For example, when the electronic device 100 is a washing machine, the function unit 180 may be configured to performing a washing operation, when the electronic device 100 is an air-conditioner, the function unit 180 may be configured to perform a cooling operation, and when the electronic device 100 is an air purifier, the function unit 180 may be configured to perform an air purifying function. However, it is merely exemplary, but the function unit 180 may perform the function of the electronic device according to the type of electronic device.

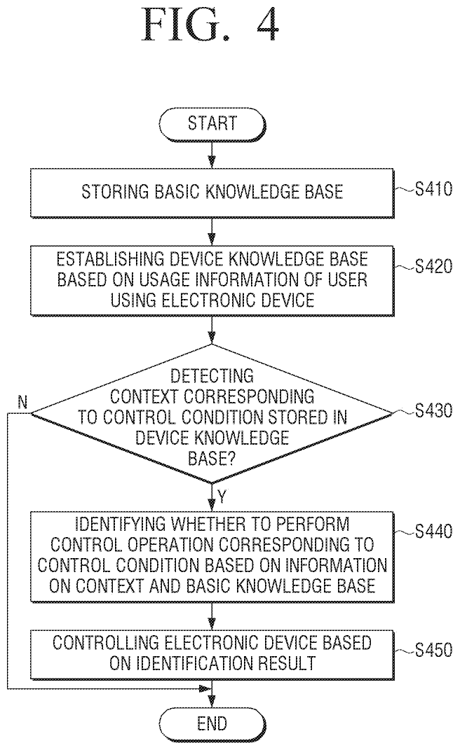

FIG. 4 is a flowchart to explain a method for performing a control operation in accordance with a context according to an embodiment of the disclosure.

The electronic device 100 may store a basic knowledge base at operation S410. The basic knowledge base may be a knowledge base that stores information related to the electronic device 100 (e.g., the function, control, setting, and structure of the electronic device 100), and could be received from an external server. However, it is merely exemplary, but the basic knowledge base could be stored at the time of manufacturing a product.

The electronic device 100 may establish the basic knowledge base based on the usage information of the user that uses the electronic device 100 at operation S420. The usage information may be information on the control command input to the electronic device 100 or the context when the control command is input. The electronic device 100 may establish the basic knowledge base by obtaining the knowledge graph including a relationship between the control condition and the control operation preferred by the user by inputting the usage information into the trained first artificial intelligence model, and establish a device knowledge base by matching a control condition with a control operation set by the user through a UI.

The electronic device 100 may determine whether the context corresponding to the control condition stored in the device knowledge base has been detected at operation 5430.

When the context corresponding to the control condition stored in the device knowledge base is sensed at operation S430-Y, the electronic device 100 may determine whether to perform a control operation corresponding to the control condition based on the information on the context and the basic knowledge base at operation 5440. To be specific, the electronic device 100 may determine whether to perform a control operation corresponding to the control condition by determining whether the result of performing a control operation on the sensed context is different from a result of performing a control operation predicted by the user based on the information on the context stored in the basic knowledge base.

The electronic device 100 may control the electronic device 100 based on a determination result at operation 5450. When the result of performing the control operation based on the sensed context is the same as the result of performing the control operation predicted by the user, the electronic device 100 may perform a control operation, and when the result of performing the control operation based on the sensed context is different from the result of performing the control operation predicted by the user, the electronic device 100 may not perform the control operation, but may provide recommendation information for the result of performing the control operation predicted by the user.

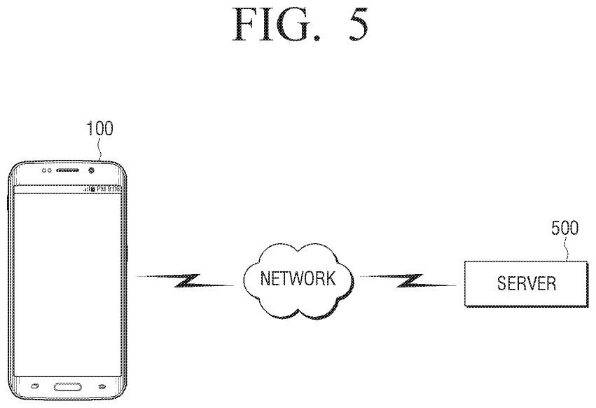

FIGS. 5, 6, and 7 are views to explain a method for establishing a knowledge base according to various embodiments of the disclosure.

Referring to FIG. 5, a system for obtaining a device knowledge base for a user may include an electronic device 100 and a server 500.

The electronic device 100 may collect a control command on the electronic device and context information, input the collected control command and context information into at least one artificial intelligence training model to establish a device knowledge base that stores information related to a user. The information on the user stored in the device knowledge base may be stored in the form of a knowledge graph. The electronic device 100 may receive a knowledge graph generated by the server 500 from the server 500, and expand the knowledge graph stored in the device knowledge base by using the knowledge graph received from the server and at least one artificial intelligence training model. The knowledge graph generated and expanded by the electronic device 100 may include information related to privacy of the user, and the knowledge graph including the privacy information may be used and managed in the electronic device 100.

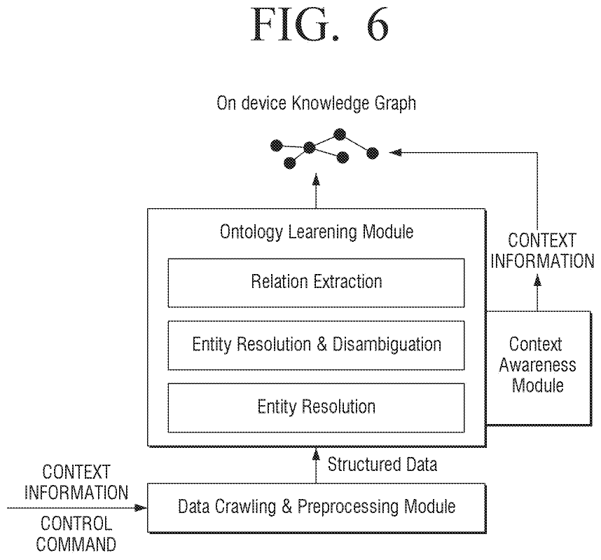

Referring to FIG. 6, an electronic device 100 may collect and pre-process control commands of a user and context information to generate structured data and generate a first knowledge graph using the structured data. The structured data, for example, may be a context indicating time series operation, or may be a sentence indicting the control command and the context related to the electronic device 100 and/or the user.

The electronic device 100 may input the structured data to the first artificial intelligence model and the first artificial intelligence model may generate the first knowledge graph through entity extraction, entity resolution and disambiguation, and relation extraction by using the structured data as an input value.

The first graph may be a knowledge graph generated based on the context related to the user and/or the electronic device 100, and could be generated by reflecting the information on the privacy of the user. The first artificial intelligence model may be a training model for generating and updating the knowledge graph based on the context of the user and/or the electronic device 100.

The artificial intelligence model may be an artificial intelligence algorithm that can be trained using at least one of machine learning, neural network, gene, deep learning, and classification algorithms. The first artificial intelligence model may provide a function of extracting entities in information on control commands and contexts and inferring relationships between the extracted entities.

The electronic device 100 may generate the first knowledge graph for each predetermined category. The electronic device 100 may generate the first knowledge graph according to the privacy level for protecting personal information of the user. The privacy level may indicate the degree of protecting the personal information of the user, and according to the privacy level, the degree of abstracting data related to the privacy of the user among data in the first knowledge graph may be determined.

The electronic device 100 may generate a device knowledge base based on the first knowledge graph, and store the first knowledge graph in a conventionally generated device knowledge base.

The electronic device 100 may request the second knowledge graph to the server 500. The electronic device 100 may transmit information on the user and the information on the electronic device to the server 500, and request the second knowledge graph to the server 500.

The second knowledge graph may be a knowledge graph generated by the sever 500, and it may be based on big data received from various users and devices. The big data used for generating the second knowledge graph may include context information related to the various situations, except for the information on the privacy. The second knowledge graph may be generated by a predetermined artificial intelligence training model using big data as input values, for example, it may be generated for each user characteristic and by category.

The electronic device 100 may receive the second knowledge graph from the server 500. The electronic device 100 may receive the second knowledge graph related to the user. The electronic device 100 may receive the second knowledge graph related to the category (or electronic device) selected by the user.

The electronic device 100 may obtain a third knowledge graph to be stored in a device knowledge base by inputting the first knowledge graph and the second knowledge graph into the second training model. The third knowledge graph may be a knowledge graph expanded from the first knowledge graph. The second training model may be a training model that can expand and update the first device knowledge graph.

The second learning model may be trained using at least one of machine learning, neural network, gene, deep learning, and classification algorithms as artificial intelligence algorithms. The second learning model can provide a function to expand the first knowledge graph by analyzing and integrating the first knowledge graph and the second knowledge graph.

The electronic device 100 may expand the knowledge graph stored in the device knowledge graph in association with the external server 500 as well as generating or adding (updating) the device knowledge base based on information on the control command and the context.

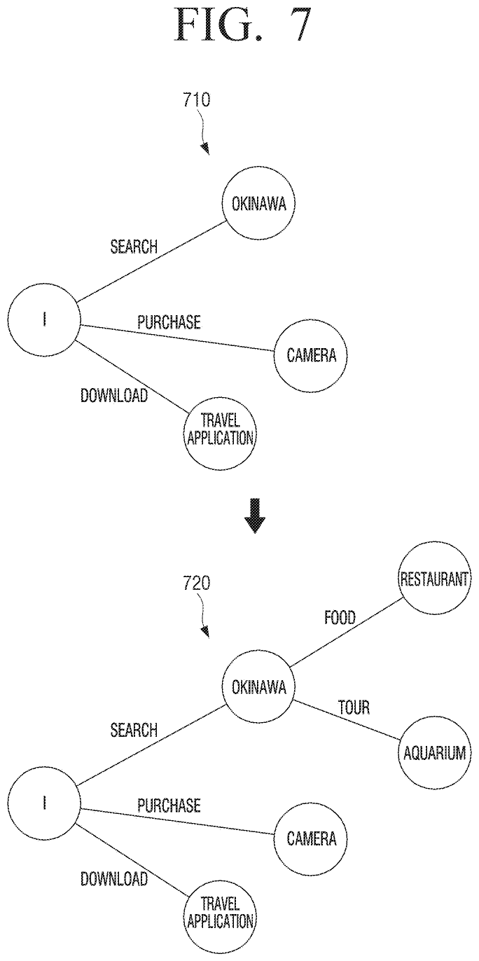

Referring to FIG. 7, the entity of a first knowledge graph 710 may include ‘I’, ‘Okinawa’, ‘camera’, and ‘travel application’. Also, for example, the relationship between the entity ‘I’ and the entity ‘Okinawa’ may be ‘search’, and the relationship between the entity ‘I’ and the entity ‘camera’ may be ‘purchase’. The relationship between the entity ‘I’ and the entity ‘travel application’ may be ‘download’.

The electronic device 100 may generate a third knowledge graph 720 by inputting the first knowledge graph 710 and the second knowledge graph received from the server 500 to the first artificial intelligence model. The third knowledge graph 720 may be a knowledge graph expanded from the first knowledge graph 710. An entity in the first knowledge graph 710 and an entity in the server knowledge graph may be mapped according to a predetermined reference, and the entity of the second knowledge graph may be incorporated into the entity in the first knowledge graph 710 according to a predetermined reference. Thus, for example, the third knowledge graph 720 may include entities ‘restaurant’ and ‘aquarium’ extended from the entity ‘Okinawa’. Also, for example, the relationship between the entity ‘Okinawa’ and the entity ‘restaurant’ may be determined as ‘food’, and the relationship between the entity ‘Okinawa’ and the entity ‘aquarium’ may be determined as ‘tourism’.

In other words, in the above-described manner, the electronic device 100 may establish (generate or expand) the device knowledge base.

FIGS. 8, 9A, and 9B are views to explain an example embodiment for performing a control operation corresponding at least one of a plurality of users in accordance with a context according to various embodiments of the disclosure.

When a user that uses the electronic device 100 includes a plurality of users, the electronic device 100 may establish a device knowledge base corresponding to each of the plurality of users. To be specific, when a control command of a user is input, the electronic device 100 may recognize the user who inputs the control command. The electronic device 100 may analyze user voice, recognize user's face, iris, or fingerprints, or identify ID or password to recognize the user who inputs the control command. The electronic device 100 may establish a device knowledge base corresponding to the user based on the information on the control command and the context. The device knowledge base may be distinguished from another user based on the recognized user information.

For example, if the electronic device is an air conditioner (or a device that controls a home device), the electronic device 100 may include a basic knowledge base 810, a first device knowledge base 820, and a second device knowledge base 830 as shown in FIG. 8 Referring to FIG. 8, the basic knowledge base 810 may store knowledge information related to an air conditioner “when the window opens, the room temperature and the outdoor temperature become equal”, “when the air conditioner is operated, the room temperature and the set temperature of the air conditioner become equal”, “the appropriate temperature is 25 degrees”. Also, in the first device knowledge base 820, control conditions and control operations such as “if the temperature is 28 degrees or higher, windows (connected to an electronic apparatus) are opened” may be matched and stored. In addition, the second device knowledge base 830 may store the control condition and the control operation matched each other “if the temperature is 28 degrees or higher, the air conditioner is operated”.

When the context corresponding to the first control condition and the second control condition is sensed, the electronic device 100 may determine one of the first control operation and the second control operation based on the basic knowledge base that stores information on the context and information related to the electronic device, and execute the determined one between the first control operation and the second control operation. The electronic device 100 may determine the result of performing the first control operation and the result of performing the second control operation based on the information related to the context stored in the basic knowledge base, and determine a control operation having a performance result predicted by a user between the result of performing the first control operation and the result of performing the second control operation as a control operation to be executed by an electronic device.

Referring to FIG. 9A, when the context satisfying both the first control condition and the second control condition “the room temperature is 30 degrees, and the outdoor temperature is 33 degrees” is sensed, the electronic device 100 may determine one of the first control operation and the second control operation based on the information on the context and the basic knowledge base 810. The electronic device 100 may determine a result of performing the first control operation in a currently detected context situation based on the basic knowledge base 810 and the first device knowledge base 820. For example, when performing a control operation, which is an operation of opening windows, based on the first device knowledge base 820, the electronic device 100 may determine that the room temperature reaches 33 degrees because the room temperature becomes equal to the outdoor temperature when windows are open. The electronic device 100 may determine a result of performing the second control operation in the currently sensed context based on the basic knowledge base 810 and the second device knowledge base 830. For example, when performing the second control operation which is an operation of operating an air conditioner based on the second device knowledge base 830, the electronic device 100 may determine that the room temperature is 25 degrees because the room temperature is the same as an air conditioner setting temperature 25 based on the basic knowledge base 810.

The electronic device 100 may determine that the result of performing the first control operation and the result of performing the second control operation conflict with each other. Therefore, the electronic device 100 may determine to perform a control operation having a result predicted by a user based on the result of performing the first control operation and the result of performing the second control operation. For example, when it is determined that the room temperature increases as a result of performing the first control operation, and the room temperature decreases as a result of performing the second control operation, the electronic device 100 may determine the second control operation corresponding to a result predicted by the user ‘the room temperature is lowered’ as a control operation to be executed by the electronic device 100.

The electronic device 100 may control the electronic device 100 to operate a cooling operation of an air conditioner without opening windows.

Referring to FIG. 9B, when the context satisfying both the first control condition and the second control condition “the room temperature is 30 degrees, and the outdoor temperature is 24 degrees” is sensed, the electronic device 100 may determine one of the first control operation and the second control operation based on the information on the context and the basic knowledge base 810. The electronic device 100 may determine the result of performing the first control operation in the currently sensed context situation based on the basic knowledge base 810 and the first device knowledge base 820. When performing the first control operation, which is an operation of opening windows, based on the first device knowledge base 820, the electronic device 100 may determine that the room temperature is 24 degrees because the room temperature is the same as the outdoor temperature when windows are open based on the basic knowledge base 810. The electronic device 100 may determine a result of performing the second control operation in the currently sensed context based on the basic knowledge base 810 and the second device knowledge base 830. For example, when performing the second control operation which is an operation of operating an air conditioner, based on the second device knowledge base 830, the electronic device 100 may determine that the room temperature is 25 degrees because the room temperature is the same as the air conditioner setting temperature 25 when an air conditioner is opened based on the basic knowledge base 810.

The electronic device 100 may determine that the result of performing the first control operation and the result of performing the second control operation conflict with each other. Therefore, the electronic device 100 may determine to perform a control operation that has a result predicted by a user based on the result of performing the first control operation and the result of performing the second control operation. Particularly, both the first control operation and the second control operation may reduce the room temperature, but it is determined that the result of performing the first control operation costs less electrical bills, the electronic device 100 may determine the first control operation as a control operation to be executed by the electronic device 100.

Therefore, the electronic device 100 may not operate an air conditioner, and may transmit a command “open” to a window connected to the electronic device 100.

As described above, the electronic device 100 may perform an optimal control operation based on the device knowledge base corresponding to the currently sensed context among the plurality of device knowledge bases 820 and 830.

FIG. 10 is a flowchart to explain a method for performing a control operation corresponding one of a plurality of users in accordance with a context according to an embodiment of the disclosure.

The electronic device 100 may store a basic knowledge base at operation S1010. The basic knowledge base may be a knowledge base for storing information related to the electronic device 100 (e.g., the function, control, setting and structure of the electronic device 100), but may be received from an external server. However, it is merely exemplary, and the basic knowledge base could be stored at the time of manufacturing a product.

The electronic device 100 may establish a device knowledge base corresponding to each of a plurality of users based on usage information corresponding to each of the plurality of users that use the electronic device 100 at operation S1020. The usage information may be information on the control command input to the electronic device 100 and the information on the context when the control command is input. The electronic device 100 may establish the first device knowledge base by obtaining a knowledge graph including a relationship between the first control condition preferred by the first user and the first control operation by inputting the usage information of the first user to the trained first artificial intelligence model, and the second device knowledge base by obtaining a knowledge graph including a relationship between the second control condition preferred by the second user and the second control operation by inputting the usage information of the second user to the trained first artificial intelligence model. The electronic device 100 may establish a plurality of device knowledge bases by matching a control condition with the control operation predetermined by each of the plurality of users through the UI.

The electronic device 100 may determine whether to sense the context corresponding to the control condition stored in a plurality of device knowledge bases at operation S1030.

When the context corresponding to the control condition stored in the plurality of device knowledge bases is sensed at operation 5430-Y, the electronic device 100 may determine a control operation corresponding to one of a plurality of control conditions based on the information on the context and the basic knowledge base at operation S1040. To be specific, the electronic device 100 may determine the result of performing the first control operation, and the result of performing the second control operation on the sensed context based on information related to context stored in the basic knowledge base, and determine a control operation having a performance result predicted by a user between the result of performing the first control operation and the result of performing the second control operation as a control operation to be executed by the electronic device.

The electronic device 100 may control the electronic device 100 according to the determined control operation at operation S1050.

As described above, even if the control condition and the control operation stored in the plurality of device knowledge bases conflict with each other, the electronic device 100 may perform an optimal control operation according to the context.

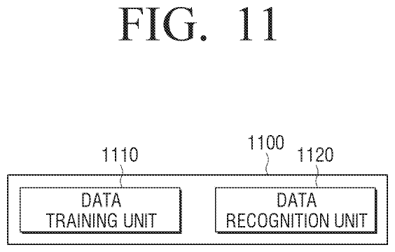

FIGS. 11, 12, and 13 are block diagrams to explain configuration of a processor according to various embodiments of the disclosure.

Referring to FIG. 11, a processor 1100 according to an embodiment may include a data training unit 1110 and a data recognition unit 1120.

The data training unit 1110 may train a reference for generating the first knowledge graph. The data training unit 1110 may train a reference on which data is to be used for generating the first knowledge graph, and how to generate the first knowledge graph using data. The data training unit 1110 may obtain data to be used for training, and apply the obtained data to the first artificial intelligence model to train a reference for generating the first knowledge graph.

The data training unit 1110 may train a reference for generating the third knowledge graph. The data training unit 1110 may train a reference on which data is to be used for generating the third knowledge graph, and how to use the third knowledge graph using the data. The data training unit 1110 may train the data used for training and apply the obtained data to the second artificial intelligence model to train a reference for generating the third graph.

The data recognition unit 1120 may output the first knowledge graph. The data recognition unit 1120 may output the first knowledge graph from predetermined data using the trained first artificial intelligence model. The data recognition unit 1120 may obtain predetermined data according to a predetermined reference by training and use the first artificial intelligence model using the obtained data as an input value to output the first knowledge graph. In addition, the result value output by the data recognition model using the obtained data as an input value may be used to renew the first artificial intelligence model.

The data recognition unit 1120 may output the third knowledge graph. The data recognition unit 1120 may output the third knowledge graph from predetermined data using the trained second artificial intelligence model. The data recognition unit 1120 may obtain predetermined data according to a predetermined reference by training, and use the second artificial intelligence model by using the obtained data as an input value to output the third knowledge graph. The result value output by the data recognition model using the obtained data as an input value may be used for renewing the second artificial intelligence model.

At least one of the data training unit 1110 and the data recognition unit 1120 may be manufactured in the form of at least one hardware chip and mounted on the electronic device. For example, at least one of the data training unit 1110 and the data recognition unit 1120 may be manufactured in the form of a dedicated hardware chip for artificial intelligence (AI), or may be manufactured as a part of a conventional general-purpose processor (CPU or application processor) or a graphics-only processor (e.g., a GPU) to be mounted on various electronic devices as described above.

In this case, the data training unit 1110 and the data recognition unit 1120 may be mounted on a single electronic device 100, or separately mounted on each electronic device. For example, one of the data training unit 1110 and the data recognition unit 1120 may be included in the electronic device 100, and the other one may be included in the server. The data training unit 1110 and the data recognition unit 1120 may be communicated in a wired or wireless manner, model information established by the data training unit 1110 may be provided to the data recognition unit 1120, and the data input to the data recognition unit 1120 may be provided to the data training unit 1110 as additional training data.

At least one of the data training unit 1110 and the data recognition unit 1120 may be embodied as a software module. When at least one of the data training unit 1110 and the data recognition unit 1120 is embodied as a software module (or, a program module including instruction), the software module may be stored in a non-transitory computer readable media. Also, in this case, the at least one software module may be provided by an operating system (OS) or by a predetermined application. Alternatively, some of the at least one software module may be provided by an Operating System (OS), and some of the software modules may be provided by a predetermined application.

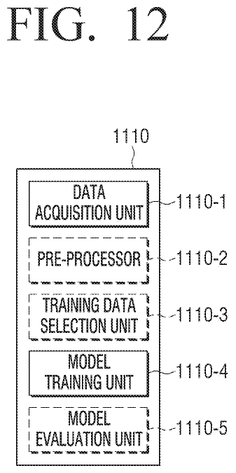

FIG. 12 is a block diagram to explain a data training unit according to some embodiments.

Referring to FIG. 12, a data training unit 1110 may include a data acquisition unit 1110-1, a pre-processor 1110-2, a training data selection unit 1110-3, a model training unit 1110-4, and a model evaluation unit 1110-5.

The data acquisition unit 1110-1 may obtain data for generating the first knowledge graph and the third knowledge graph. The data acquisition unit 1110-1 may obtain data necessary for training for the generation of the first knowledge graph and the third knowledge graph.

The pre-processor 1110-2 may pre-process obtained data so that the obtained data may be used for training for the generation of the first knowledge graph and the third knowledge graph. The pre-processor 1110-2 may manufacture the obtained data in a predetermined format such that the model training unit 1110-4 may use the obtained data for training for the generation of the first knowledge data and the third knowledge data. For example, the pre-processor 1110-2 may manufacture context information in context indicating a predetermined time series operation.

The training data selection unit 1110-3 may select data necessary for training among the pre-processed data. The selected data may be provided to the model training unit 1110-4. The training data selection unit 1110-3 may select data necessary for training among the pre-processed data according to a predetermined reference for generating the first knowledge graph and the third knowledge graph. The training data selection unit 1110-3 may select data according to a predetermined reference by training by the module training unit 1110-4.

The model training unit 1110-4 may train the reference on how to perform the generation of the first knowledge graph and the third knowledge graph based on training data. The model training unit 1110-4 may train a reference on which training data is to be used for the generation of the first knowledge graph and the third knowledge graph.

The model training unit 1110-4 may train the first and second artificial intelligence models used for the generation of the first knowledge graph and the third knowledge graph by using the training data. In this case, the first and second artificial intelligence models may be models established in advance. For example, the first and second artificial intelligence models may be models established in advance by receiving basic training data.

The first and second artificial intelligence model may be established in consideration of the application field of the recognition model, the purpose of training or the computer performance of the device. For example, the first and second artificial intelligence models may be models based on neural network. For example, A Deep Neural Network (DNN), a Recurrent Neural Network (RNN), or a Bidirectional Recurrent Deep Neural Network (BRDNN) may be used as a training model, but the disclosure is not limited thereto.

According to various embodiments, the model training unit 1110-4, when the pre-established first training model, the second training model, and the third training model are in plural, may select a training model in which the input training data and the basic training data are highly relevant to each other. In this case, the basic training data may be pre-classified by data type, and the training model may be established by data type in advance. For example, the basic training data may be pre-classified by various criteria such as an area where the training data is generated, a time at which the training data is generated, a size of the training data, a genre of the training data, a creator of the learning data, the type of objects in the training data, etc.

The model training unit 1110-4 may also train a data recognition model using a training algorithm including, for example, an error back-propagation method or a gradient descent method. However, the disclosure is not limited thereto.

The model training unit 1110-4, for example, may train the first and second artificial intelligence models through supervised learning using the training data as an input value. The model training unit 1110-4 may train the first and second artificial intelligence models through unsupervised learning that trains the type of necessary data by itself without additional supervised learning. The model training unit 1110-4 may train the first and second artificial intelligence model through reinforcement learning using a feedback whether the output result according to the training is proper.

When the first and second artificial intelligence models are trained, the model training unit 1110-4 may store the trained first and second artificial intelligence models. In this case, the model training unit 1110-4 may store the trained first and second artificial intelligence models in the memory of the electronic device 100 including the data recognition unit 1120. The model training unit 1110-4 may store the trained first and second artificial intelligence models in the memory of the electronic device 100 including the data recognition unit 1120. The model training unit 1110-4 may store the trained first and second artificial intelligence models in the memory of the server connected to the electronic device in a wired or wireless network.

In this case, the memory in which the trained first and second artificial intelligence models are stored may also store, for example, instructions or data associated with at least one other component of the electronic device. The memory may also store software and/or programs. The program may include, for example, a kernel, a middleware, an application programming interface (API), and/or an application program (or “application”).

When evaluation data is input to the first and second artificial intelligence models and a result output from the evaluation data fails to satisfy a predetermined reference, the model evaluation unit 1110-5 may allow the model training unit 1110-4 to train again. In this case, the evaluation data may be predetermined data for evaluating the first and second artificial intelligence models.

At least one of the data acquisition unit 1110-1, the pre-processor 1110-2, the training data selection unit 1110-3, the model training unit 1110-4 and the model evaluation unit 1110-5 in the data training unit 1110 may be manufactured in the form of at least one hardware chip and mounted on an electronic device.

For example, at least one of the data acquisition unit 1110-1, the preprocessor 1110-2, the training data selection unit 1110-3, the model training unit 1110-4, and the model evaluation unit 1110-5 may be manufactured in the form of a hardware chip only for the artificial intelligence (AI), or may be fabricated as part of a conventional general purpose processor (e.g., a CPU or application processor) or a graphic-only processor (e.g., a GPU) to be mounted on various electronic devices.

In addition, the data acquisition unit 1110-1, the pre-processor 1110-2, the training data selection unit 1110-3, the model training unit 1110-4 and the model evaluation unit 1110-5 may be mounted on a single electronic device or separately mounted on each electronic device. For example, part of the data acquisition unit 1110-1, the pre-processor 1110-2, the training data selection unit 1110-3, the model training unit 1110-4 and the model evaluation unit 1110-5 may be included in the electronic device, and the remaining part may be included in the server.

At least one of the data acquisition unit 1110-1, the pre-processor 1110-2, the training data selection unit 1110-3, the model training unit 1110-4, and the model evaluation unit 1110-5 may be implemented as a software module. At least one of the data acquisition unit 1110-1, the pre-processor 1110-2, the training data selection unit 1110-3, the model training unit 1110-4, and the model evaluation unit 1110-5 (or a program module including an instruction), the software module may be stored in a computer-readable non-transitory computer readable media. At least one software module may be provided by an operating system (OS) or provided by a predetermined application. Alternatively, some of the at least one software module may be provided by an Operating System (OS), and some of the software modules may be provided by a predetermined application.

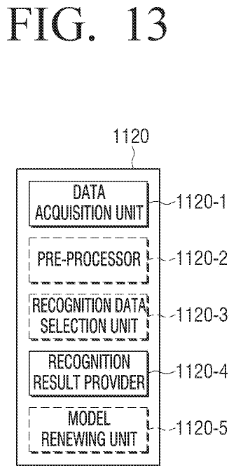

FIG. 13 is a block diagram to explain a data recognition unit according to some embodiments.

Referring to FIG. 13, a data recognition unit 1120 may include a data acquisition unit 1120-1, a pre-processor 1120-2, a recognition data selection unit 1120-3, a recognition result provider 1120-4, and a model renewing unit 1120-5.

The data acquisition unit 1120-1 may obtain data for generating the first knowledge graph and the third device knowledge graph, the pre-processor 1120-2 may preprocess the obtained data such that the obtained data may be used for generating the first knowledge graph and the third device knowledge graph. The pre-processor 1120-2 may manufacture the obtained data in a predetermined format such that the recognition result provider 1120-4 may use the obtained data for generating the first knowledge graph and the third device knowledge graph. For example, the pre-processor 1120-2 may manufacture context information in the text indicating a predetermined time series operation.

The recognition data selection unit 1120-3 may select data necessary for generating the first knowledge graph and the third device knowledge graph among pre-processed data. The selected data may be provided to the recognition result provider 1120-4. The recognition data selection unit 1120-3 may select part or all of the pre-processed data according to a predetermined reference for generating the first knowledge graph and the third device knowledge graph. The recognition data selection unit 1120-3 may select data according to a predetermined reference by the training of the model training unit 1110-4.

The recognition result provider 1120-4 may perform the generation of the first knowledge graph and the generation of the third device knowledge graph by applying the selected data to the data recognition model. The recognition result provider 1120-4 may use the data selected by the recognition data selection unit 1120-3 as an input value, and apply the selected data to the first and second artificial intelligence models. The generation of the first knowledge graph and the generation of the third device knowledge graph may be performed by the first and second artificial intelligence models.

The model renewing unit 1120-5 may renew a data recognition model based on evaluation on an output value provided by the recognition result provider 1120-4. For example, the model renewing unit 1120-5 may provide the output result provided by the recognition result provider 1120-4 to the model training unit 1110-4 such that the model training unit 1110-4 may renew the data recognition model.

At least one of the data acquisition unit 1120-1, the pre-processor 1120-2, the recognition data selection unit 1120-3, the recognition result provider 1120-4, and the model renewing unit 1120-5 in the data recognition unit 1120 may be manufactured in the form of at least one hardware chip and mounted on an electronic device. For example, at least one of the data acquisition unit 1120-1, the pre-processor 1120-2, the recognition data selection unit 1120-3, the recognition result provider 1120-4, and the model renewing unit 1120-5 may be manufactured in the form of a hardware chip only for artificial intelligence (AI), a conventional general purpose processor (e.g., a CPU or an application processor) or a graphic-only processor (e.g., a GPU) to be mounted on various electronic devices as described above.

In addition, the data acquisition unit 1120-1, the pre-processor 1120-2, the recognition data selection unit 1120-3, the recognition result provider 1120-4, and the model renewing unit 1120-5 may be mounted on a single electronic device, or separately mounted on each electronic device. For example, part of the data acquisition unit 1120-1, the pre-processor 1120-2, the recognition data selection unit 1120-3, the recognition result provider 1120-4, and the model renewing unit 1120-5 may be included in the electronic device, or the remaining part may be included in the server.

At least one of the data acquisition unit 1120-1, the pre-processor 1120-2, the recognition data selection unit 1120-3, the recognition result provider 1120-4, and the model renewing unit 1120-5 may be embodied as a software module. When at least one of the data acquisition unit 1120-1, the pre-processor 1120-2, the recognition data selection unit 1120-3, the recognition result provider 1120-4, and the model renewing unit 1120-5 is embodied as a software module, the software module may be stored in a computer-readable non-transitory computer readable media. Also, in this case, the at least one software module may be provided by an operating system (OS) or by a predetermined application. Alternatively, some of the at least one software module may be provided by an Operating System (OS), and some of the software modules may be provided by a predetermined application.

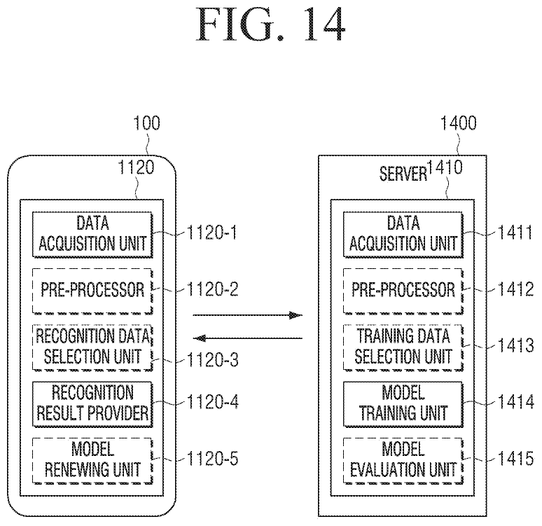

FIG. 14 is a view illustrating an example in which an electronic device is operable in association with a server to train and recognize data according to an embodiment of the disclosure.

Referring to FIG. 14, the server 1400 may train a reference for generating the first knowledge graph and the third knowledge graph, and the electronic device 100 may perform the generation of the first knowledge graph and the generation of the third knowledge graph based on the training result by the server 1400.

The model training unit 1410 of the server 1400 may perform the function of the data training unit 1110 shown in FIG. 12. The server 1400 includes a data acquisition unit 1411, a pre-processor 1412, a training data selection unit 1413, a model training unit 1414, and a model evaluation unit 1415.

The model training unit 1410 of the server 1400 may train a reference on which data is to be used for generating the first knowledge graph and the third knowledge graph and how to perform the generation of the first knowledge graph and the generation of the third knowledge graph using data. The model training unit 1410 may obtain data to be used for training and apply the obtained data to the artificial intelligence model to train a reference for the generation of the first knowledge graph and the generation of the third knowledge graph. Data related to privacy of the user of the electronic device 100 among data used by the model training unit 1410 may be data abstracted by the electronic device 100 according to a predetermined reference.

The recognition result provider 1120-4 may perform the generation of the first knowledge graph and the generation of the third knowledge graph by applying data selected by the recognition data selection unit 1120-3 to the first and second artificial intelligence models generated by the server 1400. For example, the recognition result provider 1120-4 may transmit the data selected by the recognition data selection unit 1120-3 to the server 1400, and request the server 1400 to perform the generation of the first knowledge graph and the generation of the second device knowledge graph by applying the data selected by the recognition data selection unit 1120-3 to the first and second artificial intelligence models. Data related to the privacy of the user of the electronic device 100 among data used by the recognition result provider 1120-4 and the recognition data selection unit 1120-3 may be data abstracted by the electronic device 100 according to a predetermined reference. In addition, the recognition result provider 1120-4 may receive the result value performed by the server 1400 from the server 1400.

The recognition result provider 1120-4 of the electronic device 100 may receive the first and second artificial intelligence models generated by the server 1400 from the server 1400, and perform the generation of the first knowledge graph and the generation of the third knowledge graph by using the received first and second artificial intelligence models. In this case, the recognition result provider 1120-4 of the electronic device 100 may perform the generation of the first knowledge graph and the generation of the second knowledge by applying the data selected by the recognition data selection unit 1120-3 to the first and second artificial intelligence models received from the server 1400.

The term “part” or “module” as used in this disclosure includes units composed of hardware, software, or firmware and may be used interchangeably with terms such as logic, logic block, component, circuitry, etc. The term “part” or “module” may be an integrally constructed component or a minimum unit or part thereof that performs one or more functions. For example, the module may be configured as an application-specific integrated circuit (ASIC).

Various embodiment of the disclosure may be embodied as software including commands stored in machine-readable storage media that can be read by a machine (e.g., a computer). The machine may be an apparatus that calls a command stored in a storage medium and is operable according to the called command, including an electronic device in accordance with the disclosed example embodiments (e.g., an electronic device (A)). When the command is executed by a processor, the processor may perform the function corresponding to the command, either directly or under the control of the processor, using other components. The command may include code generated or executed by a compiler or an interpreter. The machine-readable storage medium may be provided in the form of a non-transitory storage medium. The ‘non-temporary’ means that the storage medium does not include a signal but is tangible, but does not distinguish whether data is stored semi-permanently or temporarily on a storage medium.

According to an embodiment, the method according to various embodiments disclosed herein may be provided in a computer program product. A computer program product may be traded between a seller and a purchaser as a commodity. A computer program product may be distributed in the form of a machine-readable storage medium (e.g., compact disc read only memory (CD-ROM)) or distributed online through an application store (e.g., PlayStore™). In the case of on-line distribution, at least a portion of the computer program product may be temporarily stored, or temporarily created, on a storage medium such as a manufacturer's server, a server of an application store, or a memory of a relay server.

Each of the components (e.g., modules or programs) according to various embodiments may consist of a single entity or a plurality of entities, and some subcomponents of the abovementioned subcomponents may be omitted, or other components may be further included in various embodiments. Alternatively or additionally, some components (e.g., modules or programs) may be integrated into one entity to perform the same or similar functions performed by each component prior to integration. Operations performed by modules, programs, or other components, in accordance with various embodiments, may be executed sequentially, in parallel, repetitively, or heuristically, or at least some operations may be performed in a different order, or omitted, or another function may be further added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication interface;
a memory to store at least one command; and
a processor connected to the communication interface and the memory,
wherein the processor is configured to, by executing the at least one command:
based on usage information of a first user using the electronic device, establish a first device knowledge base by obtaining a first control condition and a first control operation preferred by a first user,
based on a context corresponding to the first control condition being detected, identify whether to perform the first control operation stored in the first device knowledge base based on a basic knowledge base that stores information on the context and information on the electronic device, and
based on a result of the identification, control the electronic device.

2. The electronic device as claimed in claim 1, wherein the processor is further configured to, based on a result of performing the first control operation on the detected context based on the information on the context stored in the basic knowledge base being different from a result of performing the first control operation predicted by the first user, identify not to perform the first control operation.

3. The electronic device as claimed in claim 2, wherein the processor is further configured to, based on identification not to perform the first control operation, recommend information on a second control operation for obtaining a same result as the result of performing the first control operation predicted by the first user on the context.

4. The electronic device as claimed in claim 1, wherein the processor is further configured to:
establish a second device knowledge base by obtaining a second control condition and a second control operation preferred by a second user based on usage information of a second user using the electronic device;
based on a context corresponding to the first control condition and the second control condition being detected, identify one of the first control operation or the second control operation based on the basic knowledge base that stores the information on the context and the information on the electronic device; and
execute the identified one of the first control operation or the second control operation.

5. The electronic device as claimed in claim 4, wherein the processor is further configured to:
identify a result for performing the first control operation and a result for performing the second control operation on the sensed context based on the information on the context stored in the basic knowledge base; and
identify a control operation having a result of execution predicted by a user between the result of performing the first control operation and the result of performing the second control operation as a control operation to be executed by the electronic device.

6. The electronic device as claimed in claim 1, further comprising:
a display, wherein the processor is further configured to:
control the display to display a user interface (UI) for inputting a control condition and a control operation preferred by a user, and
based on a first control condition and a first control condition being set through the UI, establish the first device knowledge base based on information on the set first control condition and first control operation.

7. The electronic device as claimed in claim 1, wherein the processor is further configured to establish the device knowledge base by obtaining a knowledge graph including information in a relation between the first control condition and the first control operation preferred by the first user by inputting the usage information of the first user to a trained first artificial intelligence model.

8. The electronic device as claimed in claim 7, wherein the first artificial intelligence model comprises an artificial intelligence model trained by using at least one of machine training, neural network, gene, deep-learning, or classification algorithm as an artificial intelligence algorithm.

9. The electronic device as claimed in claim 1,
wherein the basic knowledge base is received from an external server, or stored at the time of manufacturing the electronic device, and
wherein the basic knowledge base stores the information on the electronic device in a form of at least one knowledge graph.

10. A method for controlling an electronic device, the method comprising:
based on usage information of a first user using the electronic device, establishing a first device knowledge base by obtaining a first control condition and a first control operation preferred by a first user;
based on a context corresponding to the first control condition being detected, identifying whether to perform the first control operation stored in the first device knowledge base based on a basic knowledge base that stores information on the context and information related to the electronic device; and
based on a result of the identification, controlling the electronic device.

11. The method as claimed in claim 10, wherein the identifying of whether to perform the first control operation comprises, based on a result for performing the first control operation on the detected context based on the information on the context stored in the basic knowledge base being different from a result of performing the first control operation predicted by the first user, identifying not to perform the first control operation.

12. The method as claimed in claim 11, wherein the controlling of the electronic device comprises, based on identification not to perform the first control operation, recommending information on a second control operation for obtaining a same result as the result of performing the first control operation predicted by the first user on the context.

13. The method as claimed in claim 10, further comprising:
establishing a second device knowledge base by obtaining a second control condition and a second control operation preferred by a second user based on usage information of a second user using the electronic device;
based on a context corresponding to the first control condition and the second control condition being detected, identifying one of the first control operation or the second control operation based on the basic knowledge base that stores the information on the context and the information related to the electronic device; and
executing one of the first control operation or the second control operation.

14. The method as claimed in claim 13, wherein the determining of at least one of the first control operation or the second control operation comprises:
identifying a result of performing the first control operation and a result of performing the second operation on the sensed context based on the information related to the context stored in the basic knowledge base; and
identifying a control operation having a result of execution predicted by a user between the result of performing the first control operation and the result of performing the second control operation as a control operation to be executed by the electronic device.

15. The method as claimed in claim 10, further comprising:
displaying a user interface (UI) for inputting a control condition and a control operation preferred by a user; and
based on a first control condition and a first control operation being set through the UI, establishing the first device knowledge base based on the set first control condition and first control operation.

16. The method as claimed in claim 10, wherein the establishing of the first device knowledge base comprises, establishing the device knowledge base by obtaining a knowledge graph including information on a relation between the first control condition and the first control operation preferred by the first user by inputting the usage information on the first user into a trained first artificial intelligence model.

17. The method as claimed in claim 16, wherein the first artificial intelligence model comprises an artificial intelligence model trained by at least one of machine learning, neural network, gene, deep-learning, or classification algorithm as an artificial intelligence algorithm.

18. The method as claimed in claim 10,
wherein the basic knowledge base is received from an external server, or stored at the time of manufacturing the electronic device, and
wherein the basic knowledge base stores the information on the electronic device in a form of at least one knowledge graph.

19. The method as claimed in claim 10, further comprising:
establishing at least one device knowledge base corresponding to each of a plurality of users based on usage information corresponding to each of the plurality of users that use the electronic device.

20. The method as claimed in claim 19, wherein the usage information includes:
information on a control command input to the electronic device; and
information on a context when the control command is input.
